(19) United States
(12) Patent Application Publication
(10) Pub. No.: US 2007/0272736 A1
(43) Pub. Date: Nov. 29, 2007

(54) Systems and methods for transferring value between stored value systems

(76) Inventors: Jason Brooks, Atlanta, GA (US); J. Enrique Baca, Alpharetta, GA (US)

Correspondence Address: J. Michael Martinez de Andino, Esq.;HUNTON & WILLIAMS LLP, Riverfront Plaza, East Tower, 951 E. Byrd Street, Richmond, VA, 23219-4074, US

(21) Appl. No.: 11/440,384

(22) Filed: May 24, 2006

(51) Int. Cl. G06K 5/00; G07F 19/00; G06Q 40/00

(52) U.S. Cl. 235/379; 235/380; 705/39

(57) ABSTRACT

A system and method for providing value transfers between stored value systems is disclosed. The system generally comprises a first and second stored value account on a stored value system, and a processor associated with the stored value accounts configured to provide transfer of value from one of either the first or second stored value account to the other one of either the first or second stored value account. The method of transferring value between stored value accounts, generally comprises the steps of: receiving a communication from a user, the communication comprising information sufficient to identify a first stored value account, associating at least a second stored value account with the first stored value account; receiving a request to transfer value from the first stored value account to the second stored value account, the request comprising the amount of value to be transferred; and transferring the value.

### BACKGROUND OF THE INVENTION

This invention is generally directed to the use of stored value cards and systems. More particularly, the invention is directed to systems and methods for transferring value from one stored value account or system to at least a second stored value account or system.

Stored value cards are becoming more prominent in everyday life. These cards range from closed loop gift cards, such as a gift card to a particular restaurant, to open loop branded cards, such as a Visa® branded gift card for use in any location that accepts Visa®. “Closed loop” stored value cards and stored value systems only provide for redemption at the issuer or an affiliate of the issuer of the stored value card. “Open loop” stored value cards and stored value systems provide for redemption at a variety of merchants, including those that are not affiliated with the issuer. Stored value cards are popular for a variety of uses, three of which are worth noting.

The first is the use of such stored value cards for gifts. A gift-giver can purchase a stored value card redeemable for goods or services that the gift-giver believes the gift-receiver may enjoy. This widespread use of stored value cards as gifts has resulted in large amounts of unused value. Recent figures indicate that in 2004 over $18 billion in stored value cards were issued, and between $900 million to $1.8 billion is yet unredeemed. The reasons for the high level of unredeemed stored value cards are many, including cards being misplaced or lost, minimal amounts left on multiple cards, stored value cards being unused due to lack of interest of the holder in redeemable products or services, etc.

The second use is for the segment of the population that remains unbanked. This segment utilizes stored value cards similar to how the banked population utilizes credit or debit cards or checking accounts. For example, a teenager may not have a bank from which to pay for his or her wireless telephone bill, and may instead opt to fund the wireless telephone through wireless prepaid airtime cards or the like. Similarly, rather than provide a potentially irresponsible person with a credit card, such person may be supplied with a stored value card rather than a credit card, with a limited amount of accessible funds.

The third use of stored value cards is for the distribution of value. Value is distributed in multiple ways: an employee receiving his or her pay from an employer; a person providing a family member or friend in a different geographical area or location value; and a person providing creditors (such as for telecommunication services, cable services, rent, etc.) with value. Each of these transactions can and presently is accomplished through the use of stored value cards. Employers may provide employees with a stored value card representing the amount of the paycheck; parents may send children in college stored value cards redeemable for gasoline; family members may send other family members in different areas or countries funds stored on stored value cards rather than mail cash; unbanked members of the population providing payment to creditors through the use of stored value cards (e.g., bill pay cards), etc.

In each of the three uses discussed above, a inherent limitation to stored value cards is the inability to transfer value from one stored value card or account to another. This inability often results with a user in possession of a certain amount of value redeemable only for a good or service that is undesirable to the user.

Accordingly, there is a need for a system and method that may be used to transfer value from one stored value account or system to a different stored value account or system.

### SUMMARY OF THE INVENTION

Aspects of the invention include systems and methods for providing value transfers between stored value systems is disclosed. The system generally comprises a first and second stored value account on a stored value system, and a processor associated with the stored value accounts configured to provide transfer of value from one of either the first or second stored value account to the other one of either the first or second stored value account. The method of transferring value between stored value accounts, generally comprises the steps of: receiving a communication from a user, the communication comprising information sufficient to identify a first stored value account, associating at least a second stored value account with the first stored value account; receiving a request to transfer value from the first stored value account to the second stored value account, the request comprising the amount of value to be transferred; and transferring the value.

It is to be understood that both the foregoing general description and the following detailed description are exemplary and explanatory only, and are not restrictive of the invention as claimed. The accompanying drawings constitute a part of the specification, illustrate certain embodiments of the invention and, together with the detailed description, serve to explain the principles of the invention.

### BRIEF DESCRIPTION OF THE DRAWINGS

In order to assist in the understanding of the invention, reference will now be made to the appended drawings, in which like reference characters refer to like elements. The drawings are exemplary only, and should not be construed as limiting the invention.

FIG. 1 is a schematic representation of a stored value transfer system in accordance with some embodiments of the invention.

FIG. 2 is a schematic representation of a stored value transfer system in accordance with some embodiments of the invention.

FIG. 3 is a schematic representation of a stored value transfer system in accordance with some embodiments of the invention.

FIG. 4A and 4B are flow diagrams depicting a method of transferring stored value in accordance with some embodiments of the invention.

FIG. 5 is a flow diagram depicting a method of transferring stored value in accordance with some embodiments of the invention.

FIG. 6A and 6B are flow diagrams depicting a method of transferring stored value in accordance with some embodiments of the invention.

### DETAILED DESCRIPTION OF THE INVENTION

Reference will now be made in detail to embodiments of the invention, examples of which are illustrated in the accompanying drawings.

A system and method for the transfer of value between two different stored value accounts and systems is provided. The value may comprise monies, such as U.S. dollars, Mexican Pesos, European Euros, Japanese Yen, etc. The value may also comprise other denominations, such as wireless prepaid airtime minutes, “points,” or other such stored value. The users of stored value systems are to be understood to have accounts with such systems. It is typical for the user to possess a physical card that is associated with the user's account in the stored value system. This card may comprise various indicia used for activating, identifying, verifying, reloading (i.e. adding additional value) or otherwise using the stored value account. However, it is to be understood that the physical card is not necessary, and that the users of various stored value systems may have, if any, varied indicia of their stored value accounts.

For ease of discussion, it is to be understood that if a user is using a stored value system, the user has an account with the stored value system. The user's account may be pre-established, or may be established at the time of first use. Accordingly, if a user adds value to the stored value system, the user is adding value to the user's account with the stored value system.

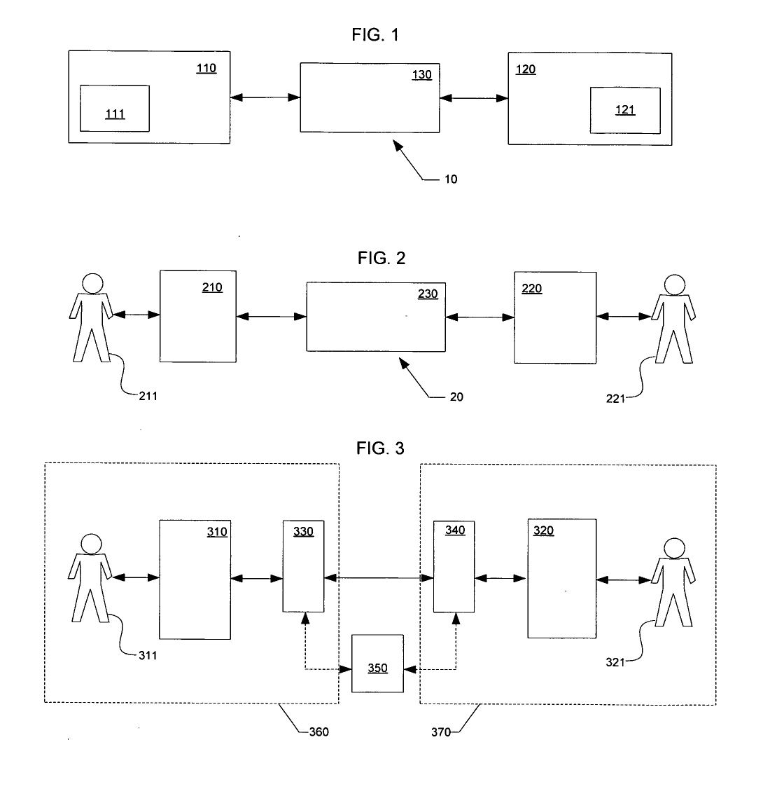

A system for transferring value in accordance with some embodiments of the present invention is graphically illustrated in FIG. 1. With reference to FIG. 1, the system 10 is comprised generally of a first stored value system 110, a second stored value system 120, and an intermediate system 130. The first stored value system 110 may be comprised of at least a stored value account 111, and the second stored value system 120 may be similarly comprised of at least a stored value account 121. The intermediate system 130 may be associated with both the first and the second stored value systems 110, 120 so as to provide communication between the systems.

The intermediate system 130 may be in a variety of forms. The intermediate system 130 may be an entirely separate entity of either the first or second stored value systems 110, 120, or in the alternative the intermediate system may be a component of either the first or second stored value systems 110, 120. The intermediate system 130 may provide for direct transfer of funds from the first stored value system 110 to the second stored value system 120, or from the second stored value system 120 to the first stored value system 110.

It is to be understood that the present invention is not limited to two stored value systems. It is contemplated that the present invention may be applied to any number of stored value systems.

A user must have an account with both the first stored value system 110 and the second stored value system 120. The user then contacts the intermediate system 130 and requests a fund transfer from one stored value system to another. Alternatively, the user may contact either the first or the second stored value system 110, 120, which may in turn initiate the transaction or provide access to the intermediate system 130 for the user.

The user may contact the intermediate system 130 or the first or second stored value systems 110, 120 in order to initiate a fund transfer in several ways. The user may call or may otherwise contact (e.g., via the internet, text-messaging (SMS), radio frequency identification (RFID) technology, etc.) the intermediate system 130 or the first or second stored value systems 110, 120. Any type of contact may result in the user interacting with a customer service representative or interacting with an automated system (e.g., interactive voice response (IVR) systems).

The intermediate system 130 may be notified of the user's account with the first stored value system 110. This notification may be express, or may be an automatic feature upon the user contacting the intermediate system 130 or the first or second stored value systems 110, 120. If the user contacts the intermediate system 130, the intermediate system may verify that the user has an active account with the first stored value system 110. Upon a positive determination, the intermediate system 130 may present the user with several options.

The intermediate system 130 may request the user to identify at least a second account at the second value system 120. The user may be able to enter additional stored value accounts at additional stored value systems. If the user has entered multiple accounts, the intermediate system 130 may request the user select an originating stored value account and a depository stored value account for the transaction.

Upon this selection, the intermediate system 130 may present the user with a variety of denominations that may be transferred (e.g., multiples of $5, $10, $25, etc.). Alternatively, the intermediate system may request a user input for a transfer in any selected amount (requiring an integer value for cents).

Once the user selects the amount to be transferred, the intermediate system 130 may verify that the requested amount of funds are available in the originating stored value account, and that the deposit of such funds in the depository stored value account is permissible.

If the originating stored value account and depository value account are in different countries, or are in different denominations (e.g., U.S. Dollar vs. Mexican Peso; U.S. Dollar vs. European Euro; U.S. Dollar vs. Minutes of Airtime; etc.) the user may be informed of the present exchange rate between the different denominations. The user may also be informed of what the final value will be after transfer, after subtracting any transaction fees that may be applicable. If the user finds the exchange rate and relevant fees acceptable, the user may authorize the transaction.

If the user does not find the exchange rate, relevant fees, or any other characteristic of the transaction acceptable, the user may withdraw from the transaction at any time with no penalty or ill-effects.

When the transaction is authorized, the intermediate system 130 may withdraw the desired amount from the first stored value system 110, and place it in a queue to be deposited in the second stored value system 120. Various transfers may be grouped together and submitted as batch transfers from the first stored value system 110 to the second stored value system 120, or may follow automated clearing house (ACH) rules and protocol. Alternatively, the transfer could occur automatically through electronic funds transfer protocol.

Regardless of whether the transfer occurs singularly or as part of a batch transaction, upon conclusion of the transfer, the second stored value system 120 may provide a value transfer account confirmation to the intermediate system 130 which may then pass on the confirmation to the user. The value transfer transaction is now complete.

If the user wishes to stop the transaction from occurring, the transaction may be either voided or cancelled, depending on when in the transaction stream the stop order is issued. The transaction may be voided any time between when the customer approves the transaction to when the funds are actually received in the second stored value system 120. The transaction may be cancelled any time between when the funds are transferred to the second stored value system 120 and when the funds are withdrawn from the second stored value system 120, through additional transfer, use, expenditures, etc. The system may allow the transaction to be cancelled up until either the transferred funds in the second stored value account 120 are used, or when a specified amount of time has passed (e.g., thirty days).

Although the intermediate system 130 may be designed such that transactions in their entirety must be voided or cancelled, it is contemplated that partial cancellations may be possible. A partial cancellation may occur if the user initially requests and approves a transfer of a certain amount (e.g., $110) and then wishes for only a portion of that initial amount to be transferred (e.g., $75) resulting in a partial cancellation of the difference (e.g., $25).

The above discussion is generally a broad overview of the system, in that it does not discuss various communications that must exist between banking institutions and other entities that hold the value associated with the stored value account. With reference to FIG. 2, the intermediate system may be omitted if a first stored value system 210 is in communication with a second stored value system 220. In the system 20 illustrated in FIG. 2, the first and second stored value systems 210, 220 are depicted with a banking institution 230 intermediate. In this situation, the banking institution may be the banking institution used by both the first stored value system 210 and the second stored value system 220. In other words, any financial transfers that may occur between the first and second stored value systems 210, 220 will occur only within the banking institution 230.

In order for a user to transfer funds from the first stored value system 210 to the second stored value system 220 the user must, as above, initiate a transaction. The first stored value system 210 may then communicate directly with the second stored value system 220. With reference to FIG. 2, data communication exists between the first stored value system 210 and the second stored value system 220, while financial transfers occur between the first stored value system 210, the banking institution, 230, and the second stored value system 220. This may allow a user of both stored value systems 210, 220 to transfer funds between them.

In addition, a user 211 of the first stored value system 210 may use the present invention to transfer funds to a different user 221 of the second stored value system 220. The user 211 of the first stored value system 210 may need to specify which account at which second stored value system 220 the particular second user 221 has, to which the first user 211 wishes to transfer funds.

Continuing with FIG. 2 and the interaction between a first and a second user 211, 221, it can then be seen that the first user 211 may add value to the first user's 211 stored value account with the first stored value system 210. The first user 211 may then elect to transfer funds to the particular account of the particular second stored value system 220 of the particular second user 221. The second user 221 may then spend, withdraw, or otherwise use the transferred funds in accordance with the various rules and limitations of the second stored value system 220.

With reference to FIG. 3, it can be seen that the present invention can be adapted for use when the stored value systems do not share a banking institution. In this scenario, a first user 311 of a first stored value system 310 may elect to transfer funds to a second stored value system 320. The second stored value system may have an account of the user (e.g., the user 311 is simply transferring funds to itself but in a different stored value system), or may have an account of a second user 321 that the first user 311 selects. The first stored value system 310 may be associated with a first banking institution 330, and the second stored value system 320 may be associated with a second banking institution 340. The first user 311 may then initiate a transaction from the first stored value system 310 to the second stored value system 320. Once the proper approvals have been obtained (e.g., verification of sufficient funds, the first user 311 informed of any applicable exchange rate, etc.) the first stored value system 310 may request a value transfer from the first banking institution 330 to the second banking institution 340.

If the value transfer occurs in particular situations where other controls must be present, i.e. international transactions where foreign exchange rates apply, a third intermediate banking institution 350 may be used. The third intermediate banking institution 350 may receive the value transfer from the first banking institution 330, and may, after applying proper foreign exchange rates, transfer the value to the second banking institution 340. In this scenario, the first banking institution 330 may be in a first country 360, while the second banking institution 340 may be in a second country 370. The third intermediate banking institution 350 therefore acts as an intermediary between these two banking institutions 330, 340.

With continued reference to FIG. 3, a first user 311 in the first country 360 may therefore provide funds and/or value to a second user 321 in the second country 370. The first user 311 may provide and/or add value to the first stored value system 310, transfer the funds to the second stored value system 320, and the second user 321 (perhaps in a different country) may withdraw, spend, or otherwise use the value. The transfer of value may occur in multiple transactions. The first user 311 may transfer value into the first stored value system 310. The first stored value system 310 may transfer value to the first banking institution 330. The first banking institution 330 may transfer value to the third intermediate banking institution 350, which in turn, may transfer the value to the second financial institution 340. The second financial institution 340 may transfer value to the second stored value system 320 where the second user 321 may withdraw, spend, or otherwise use the funds.

Users may be characterized as “originating users,” or users who transfer value, and “receiving users,” or users who receive transferred value. As noted above, an originating user and a receiving user may be one and the same. Such a situation occurs when a user wishes to transfer value from its account in a first stored value system to a second stored value system. This may occur in a variety of situations, which may be dictated by the characteristics of each particular stored value system. For example, a closed loop stored value gift card system may not allow the user to purchase goods or services from non-member retailers or service providers. However, the user may also have an account with an open loop stored value system that may allow such uses. Accordingly, the user may transfer value from the closed loop stored value system to the open loop stored value system, thereby allowing the user to use the value as the user desires.

Similarly, it is contemplated that the present invention may be used to convert value from one form to another. In this use, a single user may again be the originating user and the receiving user. The user may elect to transfer value from, for example, a wireless airtime stored value account to, for example, a gasoline stored value account. Depending on the applicable transfer rates applied to such a transaction, the user may reduce the value of the wireless airtime account in order to add value to the gasoline stored value account. In this manner, the user may again use stored value as the user desires.

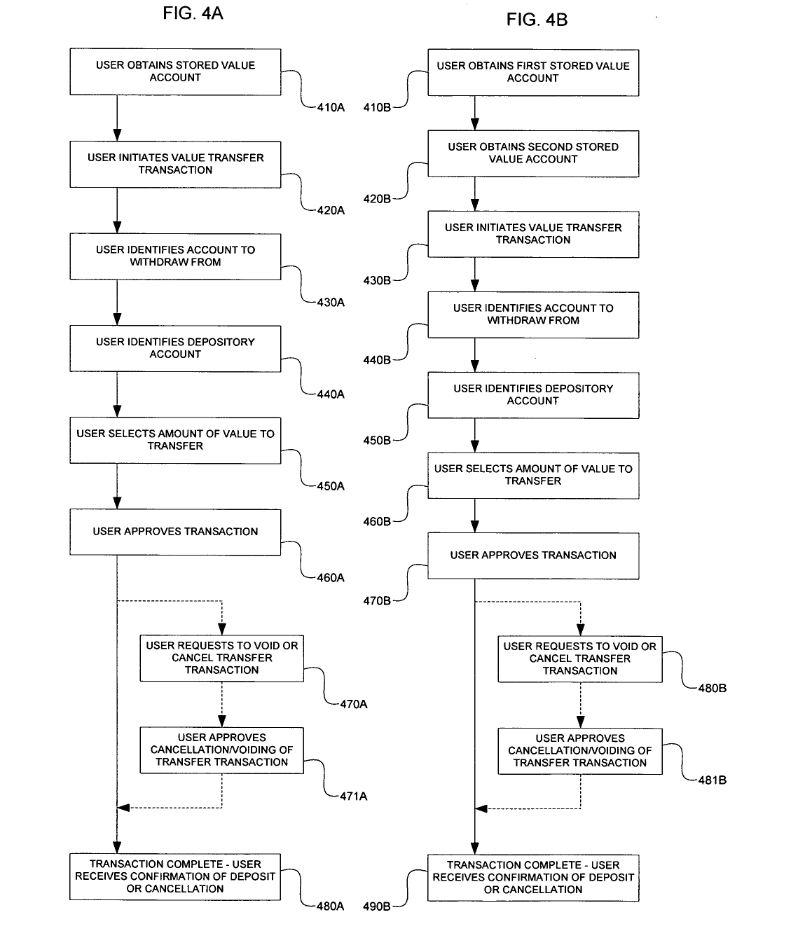

However, the originating user and the receiving user may also be different parties or entities. FIG. 4A depicts a flow-diagram illustrating the transaction steps of an originating user where the receiving user is a different party or entity than the originating user, in accordance with some embodiments of the present invention. In step 410A, the originating user enrolls in or otherwise obtains an account with a first stored value system. At step 420A, the originating user initiates a value transfer transaction. The user may initiate this transaction through a variety of manners, including a telephone call to a customer service representative of the originating or depository stored value systems, a telephone call to an interactive voice recognition system (IVR). Additionally, the user may initiate the transaction by visiting a specified webpage or through text-message or SMS technologies.

Once the originating user initiates the transaction, the originating user may select the various accounts or provide identification data at step 430A. It is contemplated that the originating user may have to enter or otherwise provide information sufficient to identify the originating stored value account and system. This information may be provided through IVR interactions, through information submitted to web pages, through text messaging or SMS communications, or through any other type of communication. Alternatively, such information could be automatically provided upon the originating user providing identification information (such as a name, personal identification number (PIN), social security number, etc.).

At step 440A, the originating user may enter information sufficient to identify the depository stored value account and system. This information may be supplied via IVR interactions, information submitted to web pages, text messaging or SMS communications, or any other type of communication. Alternatively, the originating user may have a depository stored value account and system pre-associated with the originating user. Such a situation might arise if a particular originating user is consistently using the system to send funds to a family member in a different location, for example a family member outside of the country or a child away at college.

At step 450A, the originating user may select the amount of value to transfer. The amount available to transfer may be range from a minimum amount (e.g., $5) to a maximum amount (e.g., $1,000). Amounts within this range may be limited to particular stepped values, such as multiples of $5, $10, or $20. Alternatively, the value may be fully selectable by the originating user down to the cent (e.g., $27.68). If the originating user consistently uses the system to transfer a set amount of value (e.g., $50), the system may default to such value unless altered by the originating user.

Once the originating user selects the amount of value to transfer, the transaction must be approved. Before the originating user approves the transaction, the user may be informed by the system of any applicable exchange rates, fees, etc. At step 460A the originating user approves the transaction.

Unless the originating user elects to void or cancel the value transfer, the transaction is complete. If the user elects to void or cancel the value transfer the process proceeds to step 470A. At step 470A the originating user contacts the system through one of the varied methods of communication discussed above (e.g., by telephone, IVR, webpage, text messaging/SMS, etc.). The originating user may be required to provide information sufficient to identify their stored value account and system, or such information may be automatically detected, as in step 430A above. Additionally, the originating user may be required to provide information sufficient to identify the particular value transfer transaction that the user wishes to void or cancel. Upon providing such information, the user may be presented with the status of the transaction (e.g., pending, complete, etc.) and may be notified of any ramifications of voiding or canceling the transaction (e.g., additional or unrecoverable fees, service charges, etc.).

At step 480A the originating user may approve the cancellation or voiding of the specified transaction. The originating user may be provided with information verifying that such cancellation or voiding has occurred, and that the value that was to be transferred has been returned to the originating user's account, minus any fees or service charges.

The originating user and the receiving user may be the same party or entity. FIG. 4B depicts a flow-diagram illustrating the transaction steps of an originating user where the receiving user is the same party or entity as the originating user, in accordance with some embodiments of the present invention. In step 410B, the originating/receiving user enrolls in or otherwise obtains an account with a first stored value system. At step 420B, the originating/receiving user enrolls in or otherwise obtains an account with a second stored value system. At step 430B, the originating/receiving user initiates a value transfer transaction. The user may initiate this transaction through a variety of manners, including a telephone call to a customer service representative of the originating or depository stored value systems, a telephone call to an interactive voice recognition system (IVR). Additionally, the user may initiate the transaction by visiting a specified webpage or through text-message or SMS technologies.

Once the originating/receiving user initiates the transaction, the originating user may select the various accounts or provide identification data at step 440B. It is contemplated that the originating/receiving user may have to enter or otherwise provide information sufficient to identify the originating stored value account and system. This information may be provided through IVR interactions, through information submitted to web pages, through text messaging or SMS communications, or through any other type of communication. Alternatively, such information could be automatically provided upon the originating/receiving user providing identification information (such as a name, personal identification number (PIN), social security number, etc.).

At step 450B, the originating/receiving user may enter information sufficient to identify the depository stored value account and system. This information may be supplied via IVR interactions, information submitted to web pages, text messaging or SMS communications, or any other type of communication. Alternatively, the originating/receiving user may have a depository stored value account and system pre-associated with the originating user. Such a situation might arise if a particular originating/receiving user is consistently using the system to transfer funds to a different stored value account and system.

At step 460B, the originating/receiving user may select the amount of value to transfer. The amount available to transfer may be range from a minimum amount (e.g., $5) to a maximum amount (e.g., $1,000). Amounts within this range may be limited to particular stepped values, such as multiples of $5, $10, or $20. Alternatively, the value may be fully selectable by the originating/receiving user down to the cent (e.g., $27.68). If the originating/receiving user consistently uses the system to transfer a set amount of value (e.g., $50), the system may default to such value unless altered by the originating/receiving user.

Once the originating/receiving user selects the amount of value to transfer, the transaction must be approved. Before the originating/receiving user approves the transaction, the user may be informed by the system of any applicable exchange rates, fees, etc. At step 470B the originating/receiving user approves the transaction.

Unless the originating/receiving user elects to void or cancel the value transfer, the transaction is complete. If the user elects to void or cancel the value transfer the process proceeds to step 480B. At step 480B the originating/receiving user contacts the system through one of the varied methods of communication discussed above (e.g., by telephone, IVR, webpage, text messaging/SMS, etc.). The originating/receiving user may be required to provide information sufficient to identify their stored value account and system, or such information may be automatically detected, as in step 440B above. Additionally, the originating/receiving user may be required to provide information sufficient to identify the particular value transfer transaction that the user wishes to void or cancel. Upon providing such information, the user may be presented with the status of the transaction (e.g., pending, complete, etc.) and may be notified of any ramifications of voiding or canceling the transaction (e.g., additional or unrecoverable fees, service charges, etc.).

At step 481B the originating/receiving user may approve the cancellation or voiding of the specified transaction. The originating user may be provided with information verifying that such cancellation or voiding has occurred, and that the value that was to be transferred has been returned to the originating/receiving user's originating account, minus any fees or service charges.

If the value transfer has not been cancelled or voided, at step 490B, the originating/receiving user may receive a notification that the transfer has been completed and that the requested value has been added to the depository stored value account and system. This notification may be provided by an intermediate system, by the depository stored value system, or by the originating stored value system.

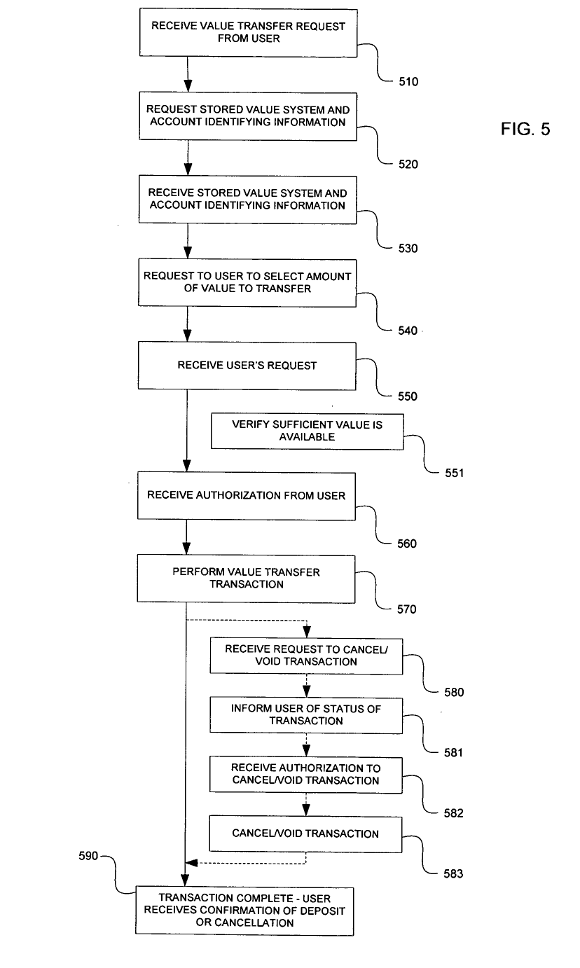

With reference to FIG. 5, a method of value transfers 50 using some embodiments in accordance with the present invention will now be discussed in terms of the system steps. As noted above, the system that conducts the value transfer may exist on an intermediate system (as in FIG. 1) or may be an attribute of a stored value system (as in FIG. 2). The discussion below is separated into these two variations of the system construction.

In the scenario where the value transfer is conducted by an intermediate system, at step 510 the intermediate system may be contacted by the originating user (or by the originating user via the first stored value system) in order to request a transfer. The intermediate system may request various identifying information from the originating user at step 520. At step 530, the intermediate system may receive identifying information from the originating user sufficient to identify the originating stored value account and system, and sufficient to identify the depository stored value account and system, and the intermediate system may verify the particular accounts.

The intermediate system may then, at step 540, send a request to the originating user to select an amount of value to transfer. At step 550 the intermediate system may receive the originating user's selected value. Optionally, at step 551, the intermediate system may verify that sufficient value exists in the originating user's stored value account and system, and may inform the originating user of any applicable transfer rate, fees, services charges, etc.) and request final approval.

At step 560 the intermediate system may receive final approval from the originating user, and may transfer value from the originating user's stored value account and system to the intermediate system. At step 570, the intermediate system may transfer the value to the depository stored value account and system. The transfer to the depository stored value systems may occur in batch form, and therefore may not occur immediately following the withdrawal from the originating stored value account and system.

Unless the originating user elects to void or cancel the value transfer, the transaction is complete. If the user elects to void or cancel the value transfer the process proceeds to step 580. At step 580 the intermediate system may receive from the originating user a communication that the originating user wishes to cancel or void the transaction. This communication may be in the form of a telephone, IVR, webpage, text messaging/SMS, and/or any other type of communication.

The instruction to cancel or void the transaction from the originating user may include information sufficient to identify the originating user's stored value account and system, or such information may be automatically detected by the intermediate system, based upon, for example, the number from which the originating user is calling from. At step 581 the intermediate system may be present the originating user with the status of the transaction (e.g., pending, complete, etc.) and may be notify the originating user of any ramifications of voiding or canceling the transaction (e.g., additional or unrecoverable fees, service charges, etc.) and may request approval of the instruction to cancel or void the transaction.

At step 582, the intermediate system may receive approval to cancel or void the transaction. The intermediate system may void the transaction any time between when the originating user approves the transaction to when the funds are actually received in the second stored value system. The intermediate system may cancel the transaction any time between when the value is transferred to the second stored value system and when the value is withdrawn from the second stored value system, through additional transfer, use, expenditures, etc. The intermediate system may allow the transaction to be cancelled up until either the transferred funds in the second stored value account are used, or when a specified amount of time has passed (e.g., thirty days).

At step 590 the intermediate system may provide the originating and receiving users with a verification that the transfer has been complete or that such cancellation or voiding has occurred, and that the value that was to be transferred has been returned to the originating user's account, minus any fees or service charges.

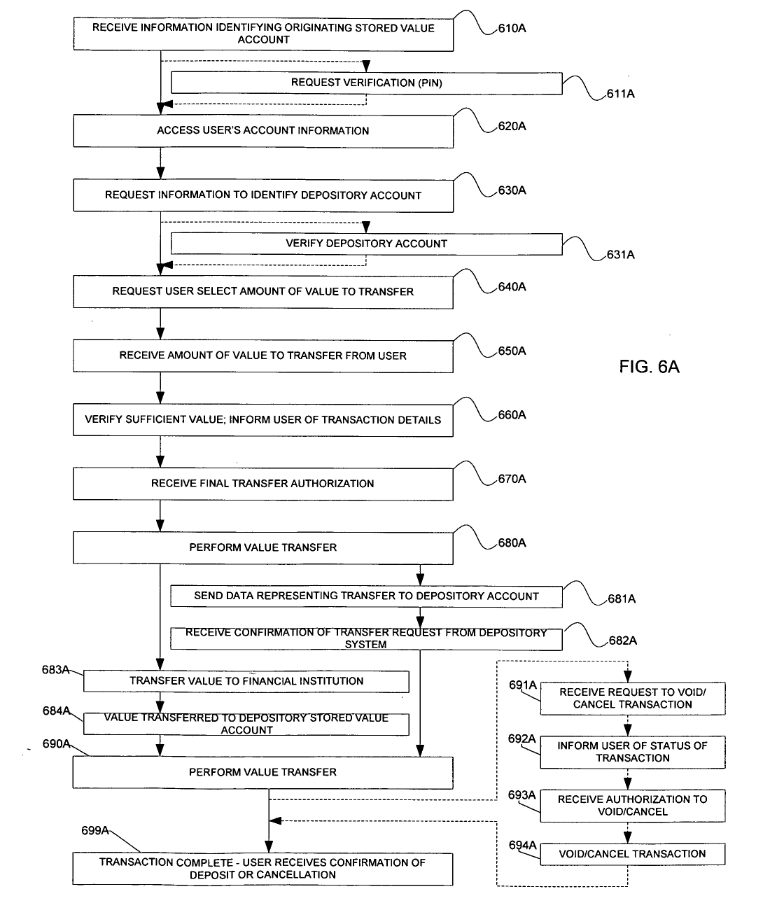

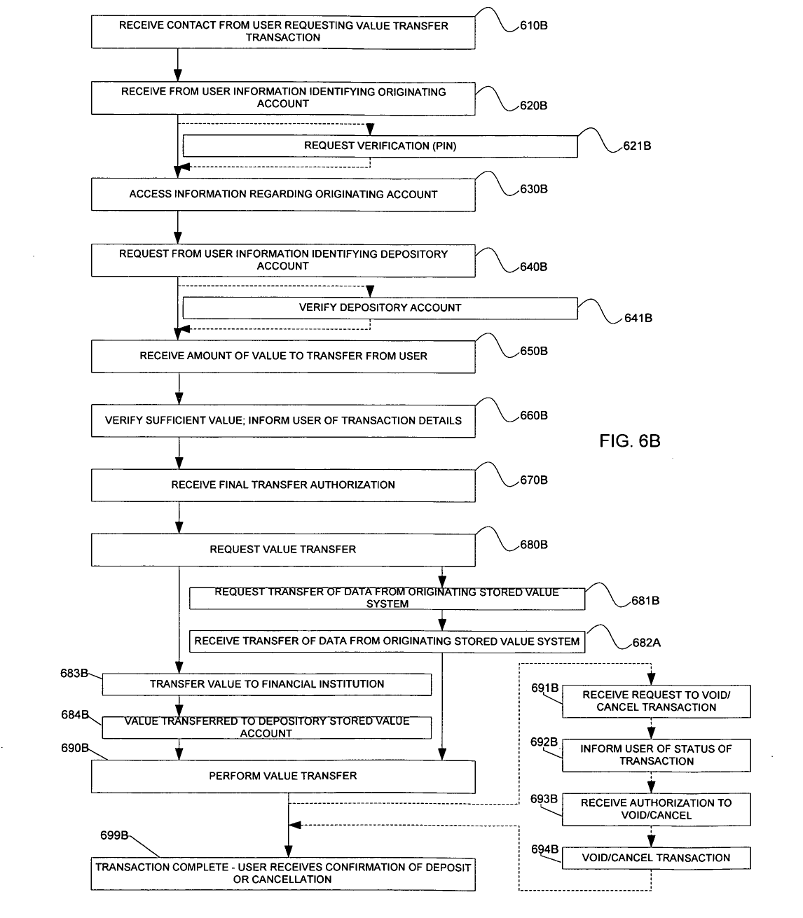

With reference to FIG. 6, a method 60 for transferring value between two or more stored value systems in accordance with some embodiments of the present invention will now be discussed. The method 60 depicted in FIG. 6, and discussed in more detail below, differs from the method 50 depicted in FIG. 5 above, in that there is no intermediate system. Instead, the method 60 may be used with a stored value system that has as a component, subcomponent, part, characteristic, or trait, the ability to transfer value from one stored value account to another stored value account on the same stored value system; or the ability to transfer value to or from one stored value account on the stored value system to at least a second stored value account on at least a second stored value system.

As in the systems discussed earlier, With reference to FIG. 5, a method of value transfers 50 using some embodiments in accordance with the present invention will now be discussed in terms of the system steps.

A distinction can be made between whether the value transfer system is a component of the originating or depository stored value system. If the value transfer system is a component of the first (originating) stored value system, the value transaction may be initiated by a user contacting or otherwise communicating a request for transfer to the first stored value system. At step 610A, the originating user may provide information sufficient to identify the originating stored value account, or such information may be automatically conveyed to the value transfer system. Optionally, at step 611A, the originating stored value system may request additional verification or authorization information from the originating user (e.g., a PIN or “secret-code”). At step 620A, the originating stored value system may automatically access information regarding the state of the originating user's account (i.e., balance, etc.). Alternatively, the user may provide or otherwise communicate such information to the originating stored value system.

At step 630A, the originating system may request the originating user provide information sufficient to identify the depository stored value system and account. Optionally, at step 631A, upon receiving such information, the originating system may verify the existence and validity of such selected depository account.

At step 640A the originating system may request the originating user select an amount of value to transfer. At step 650A, the originating system may receive the originating user's selected value, and at step 660A the intermediate system may verify that sufficient value exists in the originating user's stored value account and system, and may inform the originating user of any applicable transfer rate, fees, services charges, etc.) and request final approval.

At step 670A, the originating system may receive final approval and at step 680A may transfer value from the originating user's stored value account to the depository stored value system and account. The transfer to the depository stored value systems may occur in batch form, and therefore may not occur immediately following the withdrawal from the originating stored value account and system.

As discussed above, the actual transfer may comprise a value transfer (in a financial sense) and a database transfer. Data transfer may occur directly between the originating and depository stored value accounts. The originating stored value account may provide data to the depository stored value account representing the value transfer at step 681A, and may receive a confirmation from the depository stored value system at step 682A. Financially, the originating stored value system may, at step 683A transfer value to a financial institution. The value may be transferred through one or more additional financial institutions before arriving in its final depository location (which may be the depository stored value system, or in a financial institution associated with the depository stored value system) at step 684A.

Unless the originating user elects to void or cancel the value transfer, the transaction is complete. If the user elects to void or cancel the value transfer the process proceeds to step 691A. At step 691A the value transfer system on the originating stored value system may receive from the originating user a communication that the originating user wishes to cancel or void the transaction. This communication may be in the form of a telephone, IVR, webpage, text messaging/SMS, and/or any other type of communication.

The instruction to cancel or void the transaction from the originating user may include information sufficient to identify the originating user's stored value account and system, or such information may be automatically detected by the originating stored value system based upon, for example, the number from which the originating user is calling from. At step 692A the originating stored value system may present the originating user with the status of the transaction (e.g., pending, complete, etc.) and may be notify the originating user of any ramifications of voiding or canceling the transaction (e.g., additional or unrecoverable fees, service charges, etc.) and may request approval of the instruction to cancel or void the transaction.

At step 693A, the value transfer system on the originating stored value system may receive approval to cancel or void the transaction. The originating stored value system may void the transaction any time between when the originating user approves the transaction to when the funds are actually received in the second stored value system. The originating stored value system may cancel the transaction any time between when the value is transferred to the depository stored value system and when the value is withdrawn from the depository stored value system, through additional transfer, use, expenditures, etc.

The value transfer system on the originating stored value system may request that the transaction to be cancelled up until either the transferred funds in the second stored value account are used, or when a specified amount of time has passed (e.g., thirty days).

At step 694A the value transfer system on the originating stored value system may void or cancel the transfer. At step 699A, the originating stored value system may provide the originating user with information verifying that the transfer has occurred, or that such cancellation or voiding has occurred. If the transaction was voided or cancelled, the originating system may inform the user that the value that was to be transferred has been returned to the originating user's account, minus any fees or service charges.

If the value transfer system is a component or characteristic of the depository stored value system, the process may change somewhat. In such a situation, at step 610B, the originating user may contact the originating stored value system, which may in turn provide communication to the depository stored value system. Alternatively, the user may contact the depository stored value system directly. At step 620B, the value transfer system may receive from the originating user information sufficient to identify the originating stored value account, or such information may be automatically conveyed to the value transfer system. Optionally, at step 621B, the depository stored value system may request additional verification or authorization information from the originating user (e.g., a PIN or “secret-code”) to verify and authorize access to the originating stored value system. At step 630B, the depository stored value system may access information regarding the state of the originating user's account (i.e., balance, etc.).

At step 640B, the depository stored value system may request the originating user provide information sufficient to identify the particular depository stored value account to which such value transfer is to be made. Optionally, at step 641B, the depository stored value system may verify that the selected depository account number is accurate and the selected depository account exists.

The depository stored value system may then request the originating user select an amount of value to transfer. At step 650B the depository stored value system may receive the originating user's selected value to be transferred. At step 660B, the depository stored value system may verify that sufficient value exists in the originating user's stored value account and system, and may inform the originating user of any applicable transfer rate, fees, services charges, etc.) and request final approval.

At step 670B, the depository stored value system may receive final approval and at step 680B may request value transfer from the originating stored value system and the originating user's particular stored value account. The depository stored value system may receive value transfers from originating stored value systems in batch form, and therefore may not immediately receive transferred funds from the originating stored value account and system.

Again, as discussed above the actual transfer may comprise a value transfer (in a financial sense) and a database transfer. Data transfer may occur directly between the originating and depository stored value accounts. The depository stored value system may request a value transfer from the originating stored value system at step 681B. The originating stored value account may provide data to the depository stored value account representing the value transfer, which may be received by the depository stored value system at step 682B. Financially, the originating stored value system may, at step 683B transfer value to a financial institution. The value may be transferred through one or more additional financial institutions before arriving in its final depository location (which may be the depository stored value system, or in a financial institution associated with the depository stored value system) at step 684B.

Unless the originating user elects to void or cancel the value transfer, the transaction is carried out at step 690B and is complete. If the user elects to void or cancel the value transfer the process proceeds to step 691B. At step 691B the value transfer system on the depository stored value system may receive from the originating user a communication that the originating user wishes to cancel or void the transaction. This communication may be in the form of a telephone, IVR, webpage, text messaging/SMS, and/or any other type of communication.

The instruction to cancel or void the transaction from the originating user may include information sufficient to identify the originating user's stored value account and system and/or the depository stored value account and system, or such information may be automatically detected based upon, for example, the number from which the originating user is calling from. At step 692B the depository stored value system may present the originating user with the status of the transaction (e.g., pending, complete, etc.) and may be notify the originating user of any ramifications of voiding or canceling the transaction (e.g., additional or unrecoverable fees, service charges, etc.) and may request approval of the instruction to cancel or void the transaction.

At step 693B, the value transfer system on the depository stored value system may receive approval to cancel or void the transaction. The depository stored value system may send a request to the originating system to void the transaction any time between when the originating user approves the transaction to when the funds are actually received in the depository stored value system. The depository stored value system may cancel the transaction any time between when the value is transferred to the depository stored value system and when the value is withdrawn from the depository stored value system, through additional transfer, use, expenditures, etc. The depository stored value system may cancel the transaction by freezing the value so that it cannot be used, and transferring the value back to the particular account at the particular originating stored value system at step 694B.

At step 699B the value transfer system on the depository stored value system may provide the originating user with information verifying that the value transfer or requested cancellation or voiding has occurred. If the value transfer was voided or cancelled, the depository stored value system may inform the user that the value that was to be transferred has been returned to the originating user's account, minus any fees or service charges.

It will be apparent to those skilled in the art that various modifications and variations can be made in the method, manufacture, configuration, and/or use of the present invention without departing from the scope or spirit of the invention. For example, the stored value cards may be smart cards, biometric cards, cards equipped with magnetic stripes, bar codes, radio frequency identification tags, etc. It is likewise to be understood that the systems and methods of the invention may applied to multiple merchants operating in a consortium with a central stored value transfer system and the like. Additionally, rather than transferring value between stored value accounts, it is contemplated that the systems and methods of the invention may be used to transfer value between a stored value system and an account (e.g., checking, savings, money market, investment, etc.) at a financial institution. It is understood that such transactions may result in the use of stored value being transferred for use in such financial transactions as loan repayment, investment account deposits, etc.

What is claimed is:

1. A system for providing value transfers between stored value systems, comprising:
a first stored value account on a stored value system;
a second stored value account on a stored value system; and
a processor associated with the first stored value account and the second stored value account, wherein the processor provides transfer of value from one of either the first stored value account or the second stored value account to the other one of either the first stored value account or second stored value account.

2. The system of claim 1, wherein the stored value system is an open loop or a closed loop system.

3. The system of claim 1, wherein the first stored value account and the second stored value account are on the same stored value system.

4. The system of claim 1, wherein the first stored value account is on a first stored value system, and wherein the second stored value account is on a second stored value system.

5. The system of claim 4, wherein the first stored value system is either an open loop or closed loop system.

6. The system of claim 4, wherein the second stored value system is either an open loop or closed loop system.

7. The system of claim 1, wherein the processor is an intermediate processor, independent of the stored value system.

8. The system of claim 1, wherein the processor is associated with the stored value system.

9. The system of claim 4, wherein the processor is an intermediate processor, independent of the first stored value system and the second stored value system.

10. The system of claim 4, wherein the processor is associated with the first stored value system.

11. The system of claim 4, wherein the processor is associated with the second stored value system.

12. A system for providing value transfers between stored value systems, comprising:
a first stored value account on a stored value system;
a second stored value account on a stored value system;
a first financial institution, with the first stored value account associated therewith;
a second financial institution, with the second stored value account associated therewith; and
a processor, wherein the processor provides for a withdrawal of value from one of either the first financial institution or second financial institution, and a deposit of the withdrawn value to the other of either of the first financial institution or the second financial institution.

13. A method of transferring value between stored value accounts, the method comprising the steps of:
establishing a first stored value account with a stored value system;
associating a second stored value account with the first stored value account;
directing a processor to transfer an amount of value from the first stored value account to the second stored value account.

14. The method of claim 13, wherein the amount of value transferred from the first stored value account to the second stored value account is selected by the user.

15. The method of claim 13, wherein the first stored value account has a different denomination of value than the second stored value account.

16. The method of claim 13, further comprising the step of:
approving the transfer of value from the first stored value account to the second stored value account.

17. The method of claim 16, wherein the step of approving the transfer of value comprises:
being informed of any applicable exchange rates and fees;
being informed of the total amount of value to be added to the second stored value account; and
communicating approval of the transfer of value.

18. A method of transferring value between stored value accounts, the method comprising the steps of:
associating a first stored value account with a second stored value account;
receiving a request to transfer value from the first stored value account to the second stored value account; and
transferring value from the first stored value account to the second stored value account.

19. A method of transferring value between stored value accounts, the method comprising the steps of:
receiving a communication from a user, the communication comprising information sufficient to identify a first stored value account;
associating at least a second stored value account with the first stored value account;
receiving a request to transfer value from the first stored value account to at least a second stored value account, the request comprising the amount of value to be transferred; and
transferring value from the first stored value account to the second stored value account.

20. The method of claim 19, further comprising the step of:
communicating to the user that the transaction has been completed.
